(19) United States
(12) Patent Application Publication
(10) Pub. No.: US 2012/0110446 A1
(43) Pub. Date: May 3, 2012

(54) DATA MANAGEMENT APPARATUS, DATA MANAGEMENT METHOD, AND COMPUTER-READABLE RECORDING MEDIUM THEREOF

(75) Inventor: Takayuki KUNIEDA, Tokyo (JP)

(73) Assignee: RICOH COMPANY, LTD.

(21) Appl. No.: 13/274,588

(22) Filed: Oct. 17, 2011

(30) Foreign Application Priority Data
Oct. 29, 2010 (JP) 2010-243572

(51) Int. Cl. G06F 17/00

(52) U.S. Cl. 715/273

(57) ABSTRACT

A computer-readable recording medium on which a program is recorded for causing a computer to execute a data management method includes the steps of obtaining document identification data used for identifying a target document, obtaining page identification data used for identifying a page of the target document, obtaining document use data indicating a display time and a display location in which the page of the target document has been displayed, obtaining recording data indicating a recording time and a recording location in which AV (Audio Visual) data has been recorded in a case where the recording location is within a predetermined range from the display location, identifying a portion of the AV data corresponding to the display time of the page of the target document, and outputting access data that provides access to the portion of the AV data.

### BACKGROUND OF THE INVENTION

1. Field of the Invention

The present invention relates to a data management apparatus, a data management method, and a computer-readable recording medium thereof.

2. Description of the Related Art

By recording audio and video data pertaining to, for example, a conference or a lecture and enabling the data to be viewed and listened to afterward along with conference minutes, handouts, etc., it is possible for contents of the conference or the lecture to be reviewed or conveyed to absentees. Further, there is a system that enables contents of a presentation, a conference, a lecture or the like to be browsed together with material used in the presentation, the conference, the lecture or the like by using application software. The application software records contents of the presentation, the conference, the lecture or the like (video footage), stores the contents used in the presentation, the conference, the lecture of the like, and fabricates data enabling the recorded contents to be viewed and listened to in synchronization with the material used in the presentation, the conference, the lecture or the like.

Further, Japanese Laid-Open Patent Publication No. 2005-210408 discloses an example of a method for associating visual data to printed material where printing contents (i.e. contents to be printed) are delivered in association with visual data. With this example, a screen(s) extracted from video contents is stored in association with printing contents and allows the extracted screen and the printing contents to be simultaneously displayed in a case of printing out the printing contents. Thereby, the user can easily confirm the printing contents.

In general, the above-described system is configured to mainly display visual and audio data (hereinafter also simply referred to as “contents”) and additionally display material corresponding to the contents. Although the user can perform operations such as fast-forward or skipping with the system, it is, as a rule, necessary for the user to reproduce the entire contents for understanding the content of the contents. Therefore, in a case where the user desires to view and listen to a portion of the contents corresponding to particular material, the user needs to manually find the location corresponding to the portion of the contents by reproducing the contents. Finding the desired portion of the contents is difficult for the user.

Japanese Laid-Open Patent Publication No. 2005-210408 discloses a technology that facilitates usability for the user by storing visual contents in association with printing contents and making the visual contents available in a case where the visual contents are delivered in association with the printing contents. However, Japanese Laid-Open Patent Publication No. 2005-210408 is not aimed to facilitate reproduction of contents based on corresponding material.

### SUMMARY OF THE INVENTION

The present invention may provide a data management apparatus, a data management method, and a computer-readable recording medium that substantially eliminate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a data management apparatus, a data management method, and a computer-readable recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a computer-readable recording medium on which a program is recorded for causing a computer to execute a data management method, the data management method including the steps of: obtaining document identification data used for identifying a target document; obtaining page identification data used for identifying a page of the target document; obtaining document use data indicating a display time and a display location in which each page of the target document was displayed; obtaining recording data indicating a recording time and a recording location in which AV (Audio Visual) data was recorded in a case where the recording location is within a predetermined range from the display location; identifying a portion of the AV data corresponding to the display time of the page of the target document; and outputting access data that provides access to the portion of the AV data.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating a configuration of a data management system (network conference system) according to an embodiment of the present invention;

FIG. 2 is a block diagram illustrating a hardware configuration of a data processing terminal (user terminal) according to an embodiment of the present invention;

FIG. 3 is a block diagram for describing functions of a user terminal according to an embodiment of the present invention;

FIG. 4 is a schematic diagram illustrating an example of document use data according to an embodiment of the present invention;

FIG. 5 is a schematic diagram illustrating an example of recording data according to an example of the present invention;

FIG. 6 is a block diagram for describing functions of an application server according to an embodiment of the present invention;

FIG. 7 is a flowchart illustrating an operation of a document management application of an application server according to an embodiment of the present invention;

FIG. 8 is a schematic diagram illustrating an example of a timeline according to an embodiment of the present invention;

FIG. 9 is a schematic diagram illustrating an example of a GUI of a document management application according to an embodiment of the present invention;

FIG. 10 is a flowchart illustrating another operation of a document management application of an application server according to an embodiment of the present invention;

FIG. 11 is a schematic diagram illustrating an example of a paper on which a page of document material is printed in accordance with a function of an application server according to an embodiment of the present invention;

FIG. 12 is a flowchart illustrating another operation of a document management application of an application server according to an embodiment of the present invention; and

FIG. 13 is a schematic diagram illustrating another example of document use data according to an embodiment of the present invention.

### DETAILED DESCRIPTION OF THE PREFERRED EMBODIMENTS

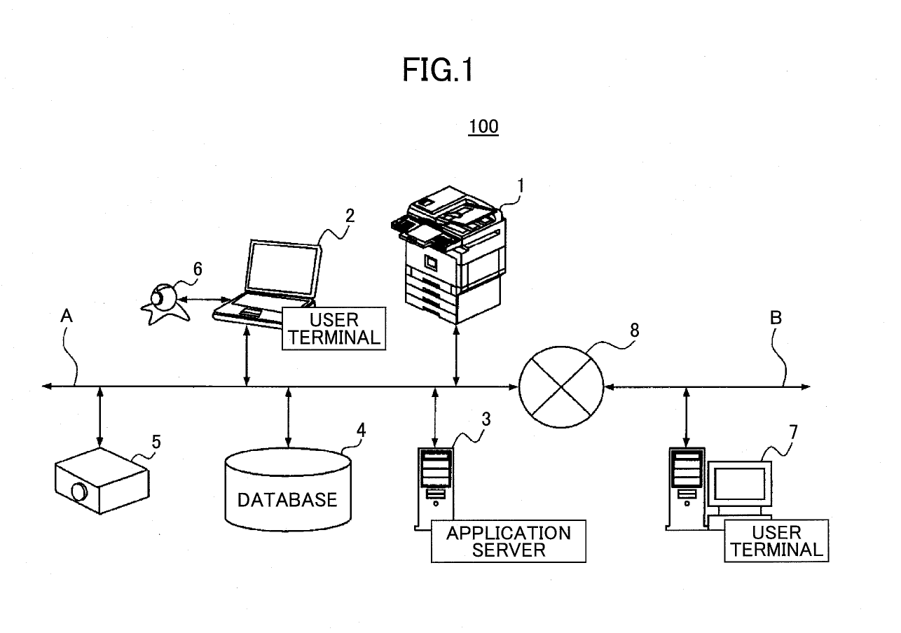

FIG. 1 is a schematic diagram illustrating a configuration of a network conference system 100 according to an embodiment of the present invention. As illustrated in FIG. 1, the network conference system 100 includes an image forming apparatus 1, a user terminal 2, an application server 3, a database 4, and a projector 5. The network conference system 100 is operated by connecting the image forming apparatus 1, the user terminal 2, the application server 3, the database 4, and the projector 5 in a network A. The image forming apparatus 1 may be, for example, a printer or a scanner that has an input function and an output function. The user terminal 2 is a data processing terminal such as a personal computer (PC) operated by the user. The application server 3 provides a service(s) via the network A. The database 4 stores data in the network A. The projector 5 projects a screen for enabling one or more users to simultaneously view the screen.

The network A is connected to a network B via a public line 8 (e.g., the Internet, public switched network). The network B is connected to a user terminal (data processing terminal) 7 operated by a user different from the user operating the user terminal 2. The user terminal 2 is connected to a web camera 6 that photographs dynamic images and inputs the images to the user terminal 2. With this configuration, the user of the user terminal 2 and other users in the vicinity of the user of the user terminal 2 can share visual data, audio data, and document material with the user of the user terminal 7 and hold a network conference with the user of the user terminal 7.

In this embodiment, the image forming apparatus 1 is a multifunction machine including functions such as a photographing function, an image forming function, and a communicating function. Thereby, the image forming apparatus 1 can be used as a printer, a facsimile machine, a scanner, and a copier. One or more applications used for holding the network meeting are installed in the user terminals 2, 7. Thereby, the user terminals 2, 7 can provide a network conference function. The application server 3 is a server in which a document management application is installed.

The database 4 stores, for example, contents data (i.e. audio/visual data), data pertaining to the time at which the contents have been recorded, data pertaining to the location of the recorded contents, data pertaining to document material, and data pertaining to the actual time at which the document data has been browsed or displayed. The projector 5 obtains data pertaining to the GUI (Graphic User Interface) of the network conference of the user terminal 2 via the network A and projects the obtained data onto, for example, a screen or a whiteboard. Although not illustrated in FIG. 1, a web camera is connected to the user terminal 7 in the same manner as the user terminal 2. Thereby, images of the user of the user terminal 7, images of other users in the vicinity of the user of the user terminal 7, or images of the scenery in the vicinity of the user of the user terminal 7 can be obtained.

In addition to including the function for achieving the network conference function, the application installed in the user terminals 2, 7 also includes a function for generating data to be stored in the database 4. The document management application, which is installed in the application server 3, includes a function for reproducing a portion of contents in correspondence with a browse location of document material based on the data stored in the database 4. The function(s) of the application installed in the user terminal 2, 7, and the application server 3 are described in detail below.

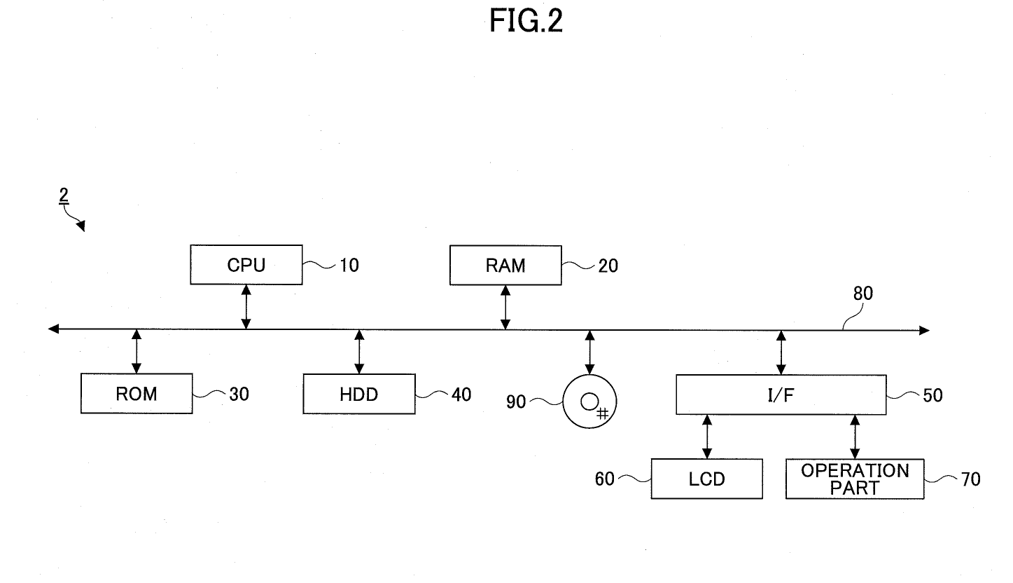

Next, a hardware configuration of the image forming apparatus 1, the user terminals 2, 7, the application server 3, and the database 4 is described with reference to FIG. 2. FIG. 2 is a block diagram illustrating a hardware configuration of the user terminal 2 according to an embodiment of the present invention. It is to be noted that, although only the hardware configuration of the user terminal 2 is described below, the description of the hardware configuration of the user terminal 2 basically applies to the hardware configuration of the image forming apparatus 1, the application server 3, the database 4, and the user terminal 7.

As illustrated in FIG. 2, the user terminal 2 has substantially the same configuration as the hardware configuration of, for example, a typical server or a personal computer. In this embodiment, the user terminal 2 includes, for example, a CPU (Central Processing Unit) 10, a RAM (Random Access Memory) 20, a ROM (Read Only Memory) 30, a HDD (Hard Disk Drive) 40, and a I/F (interface) 50 that are connected by a bus 80. An LCD (Liquid Crystal Display) 60 and an operation part 70 are connected to the I/F 50.

The CPU 10 is an arithmetic part that controls the entire operations of the user terminal 2. The RAM 20 is a volatile recording medium that can read and write data at high speed. The RAM 20 serves as a working area enabling the CPU to process data. The ROM 30 is a non-volatile recording medium dedicated for having data read out therefrom. The ROM 30 stores programs such as firmware. The HDD 40 is also a non-volatile recording medium that can read and write data. The HDD 40 stores, for example, an OS (Operating System), various control programs, and application programs.

The I/F 50 connects the bus 80 to various hardware and networks and controls the connection between the bus and the various hardware and networks. The LCD 60 is a visual user interface for enabling the user of the user terminal 2 to confirm the status of the user terminal 2. The operation part 70 is a user interface such as a keyboard or a mouse for enabling the user to input data to the user terminal 2. In a case where the application server 3 is used as a server, user interfaces such as the LCD 60 and the operation part 70 may be omitted from the configuration of the application server 3 as illustrated in FIG. 2. Further, an engine(s) for realizing a scanner function or a printer function can be added to the hardware configuration of the image forming apparatus 1 as illustrated in FIG. 2.

With the above-described hardware configuration, a program (software control part) recorded to the ROM 30, the HDD 40 or a computer-readable recording medium (e.g., optical disk) 90 is read out by the RAM 20 and executed in accordance with the controls of the CPU 10. Accordingly, with the combination of hardware and software, the functions of the user terminals 2, 7, the image forming apparatus 1, the application server 3, and the database 4 can be executed.

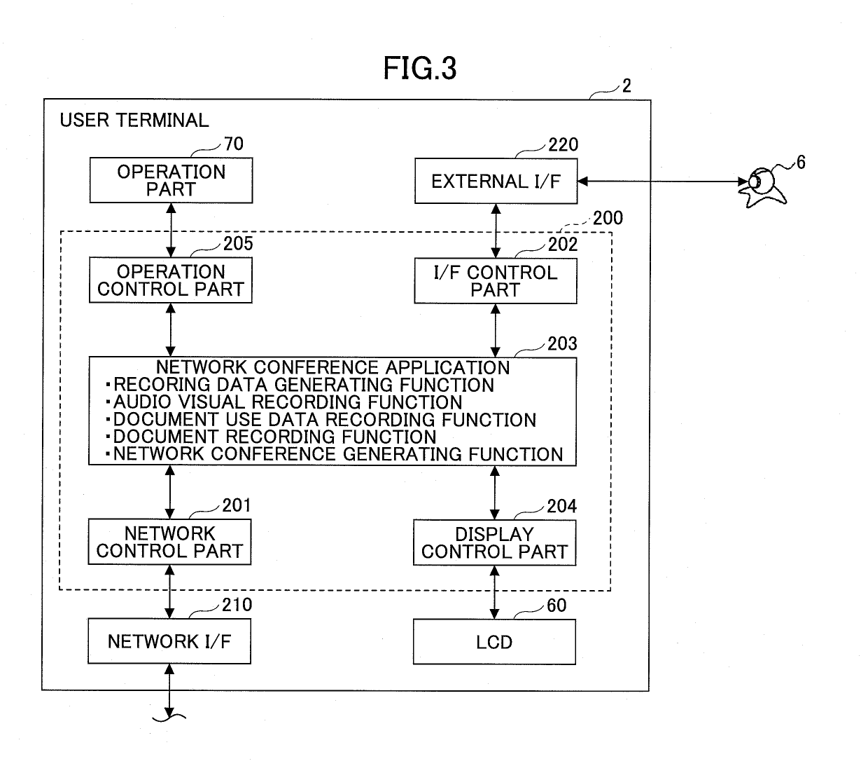

Next, the functions (functional parts) of the user terminal 2 according to an embodiment of the present invention are described. FIG. 3 is a block diagram for describing the functions of the user terminal 2 according to an embodiment of the present invention. In addition to the LCD 60 and the operation part 70 illustrated in FIG. 2, the user terminal 2 also includes a controller 200, a network interface 210, and an external I/F 220. Further, the controller 200 includes, for example, a network control part 201, an I/F control part 202, a network conference application 203, a display control part 204, and an operation control part 205.

The network I/F 210 is an interface for establishing communications between the user terminal 2 and other devices via a network (e.g., the network or A and B). The external I/F 220 is an interface for connecting the user terminal 2 to an external device (e.g., web camera). The external I/F 220 may be, for example, an Ethernet (registered trademark) or a USB (Universal Serial Bus) interface. The I/F 50 of FIG. 2 includes the network I/F 210 and the external I/F 220 and performs the functions of the network I/F 210 and the external I/F 220.

The controller 200 is a combination of hardware (e.g., integrated circuit) and software (software control part) and serves as a control part that controls the entire user terminal 2. More specifically, the functions of the controller 200 are performed by loading a program recorded to the ROM 30, the HDD, or a computer-readable recording medium (e.g., optical disk) 90 to a volatile memory (e.g., RAM 20) and performing calculations with the CPU 10 in accordance with the program.

The network control part 201 obtains data input from the network I/F 210 and transmits data to other devices via the network I/F 210. The I/F control part 202 controls external devices connected to the external I/F 220 and obtains data input from the external devices via the external I/F 220.

The functions of the network conference application 203 is performed by loading an application program recorded to the ROM 30, the HDD, or a computer-readable recording medium (e.g., optical disk) 90 to a volatile memory (e.g., RAM 20) and performing calculations with the CPU 10 in accordance with the application program. The application program is a program for realizing a network conference with other data processing terminals via a network (e.g., the network 8). One function of the network conference application 203 is a network conference function that establishes a session between the user terminal 2 and another data processing terminal having the network conference application 203 installed therein and connected to the user terminal 2 via a network (e.g., the network 8) and enables data such as presentation data and audio/visual data to be displayed to both the user terminal and the other data processing terminal.

The network conference application 203 also includes, for example, an audio visual recording function, a recording data generating function, a document recording function, and a document use data recording function. The audio visual recording function is a function that records audio and visual data that have been recorded at a network conference. The recording data generating function is a function that generates data pertaining to the recording of audio and visual data in a case where audio data or visual data is recorded. The document recording function is a function that records document material displayed at a network conference. The document use data recording function is a function that records the manner in which document material has been displayed at a network conference.

The network conference application 203 generates an AV (Audio Visual) file based on audio or visual data input to the web camera 6 via the external I/F 220 at a network conference by using the audio visual recording function. The network control part 201 stores the generated AV file in the database 4 via, for example, the network A.

The network conference application 203 retains data of document material displayed at a network conference by using the document recording function. The network control part 201 stores the retained document material in the database 4 via, for example, the network A. The recording data generating function and the document use data recording function are described in detail below.

The display control part 204 instructs the LCD 60 to display the status (e.g., GUI (Graphic User Interface) of the network conference application 203) of the user terminal 2. The operation control part 205 obtains signals corresponding to the user's operations performed on the operation part 70 and inputs the signals to corresponding software (e.g., network conference application) of the user terminal 2.

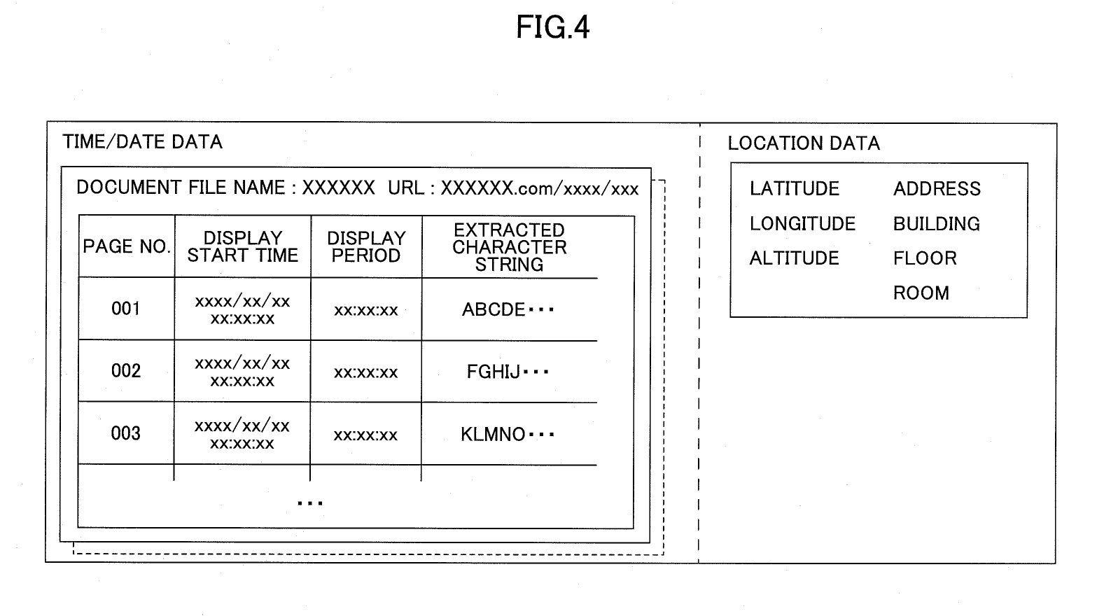

Next, the recording data generating function and the document use data recording function of the network conference application 203 according to an embodiment of the present invention are described. FIG. 4 is a schematic diagram illustrating the content of document use data generated by the document use data recording function. In a case where a network conference is held (organized), the network conference application 203 generates document use data in a case where a document file (document material) is displayed at the network conference. In this embodiment, the document use data includes, for example, “time/date data” and “location data” as illustrated in FIG. 4.

The “time/date data” includes data for specifying a document such as “document file name”, “URL (Uniform Resource Locator)”, “page number”, “display start time”, and “display period”. The “document file name” and “URL” are data that indicate a storage area in the database 4 in which document material is stored. That is, the “document file name” and “URL” are data indicating a file path of the database 4. The “page number”, “display start time”, and “display period” are timeline data for indicating a timeline in which a document file has been used. For example, the page of a displayed document file and the actual time and length of displaying the document file can be determined based on the data of “page number”, “display start time”, and “display period”.

Further, data of “extracted character string” is assigned to each “page No.” in the “time/date data”. The “extracted character string” is data indicating a character string included in the corresponding page. The “extracted character string” enables character data included in each page of a document file to be recognized. Thus, document material can be searched based on character data by referring to data of “extracted character string”. In a case where plural document files are displayed in a single network conference, the timeline data and the data of “extracted character string” are generated in correspondence with each document file in the time/date data.

On the other hand, “location data” includes data indicating the location in which a network conference has been held (i.e. location of a data processing terminal including the network conference application 203 that executed the network conference function). As illustrated in FIG. 4, the “location data” includes data pertaining to, for example, “latitude”, “longitude”, “altitude”, “building (name of building)”, “floor”, and “room (name of room)”. It is, however, to be noted that the above-described data items included in the “location data” of FIG. 4 are merely examples. Other data items indicating the location in which the network conference was held may also be included.

The “location data” of FIG. 4 may be input manually by the user when the network conference is held. Alternatively, the “location data” may be generated based on data measured by a positioning system (e.g., GPS (Global Positioning System) provided to the user terminal 2. Although the location data of FIG. 4 only includes data indicating the location of the user terminal 2, plural locations may be included in the location data. For example, the location data may include data indicating the location of the terminal of the counterpart(s) of the network conference (e.g., location of the user terminal 2 and location of the user terminal 7). Accordingly, the document use data stored in the database 4 is used as document browse data indicating the time and the location at which each page of a document was browsed. Accordingly, the database 4 functions as a document browse data storage part.

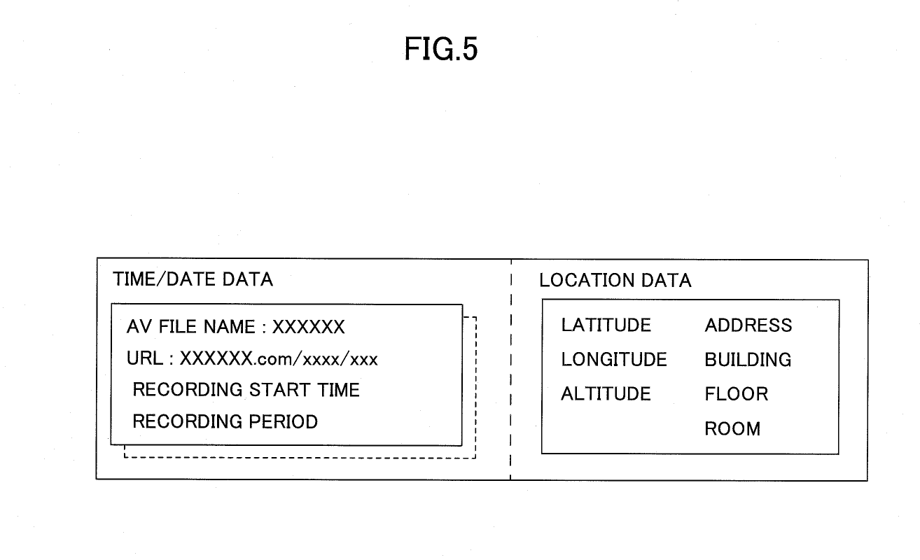

FIG. 5 is a schematic diagram illustrating an example of recording data generated by the recording data generating function according to an example of the present invention. In a case where a network conference is held (organized) by the network conference application 203, audio/visual data of the network conference is recorded and an AV (Audio Visual) file of the network conference is generated. The recording data is generated at the same time of generating the AV file. As illustrated in FIG. 5, the recording data also includes “time/date data” and “location data”.

The “time/date data” includes data for specifying an AV file such as “AV file name”, “URL (Uniform Resource Locator)”, “recording start time”, “recording period”. The “AV file name” and “URL” are data that indicate a storage area in the database 4 in which an AV file is stored. That is, the “AV file name” and “URL” are data indicating a file path of the database 4. The “recording start time” and the “recording period” are timeline data for indicating a timeline of the recording data. The “location data” is the same as the location data included in the document use data. As described above, the location data may not only include the location of one terminal of a network conference but may also include the location of a terminal of a counterpart of the network conference (e.g., location of the user terminal 2 and location of the user terminal 7). Accordingly, the recording data stored in the database 4 is used as contents recording data indicating the time and the location in which contents (audio/visual contents) were recorded. Accordingly, the database 4 functions as a contents recording data storage part.

As described above, the document use data and the recording data illustrated in FIGS. 4 and 5 are generated at a network conference by the network conference application 203. Further, the network control part 201 stores the generated document use data and the recording data in the database 4 via, for example, the network A.

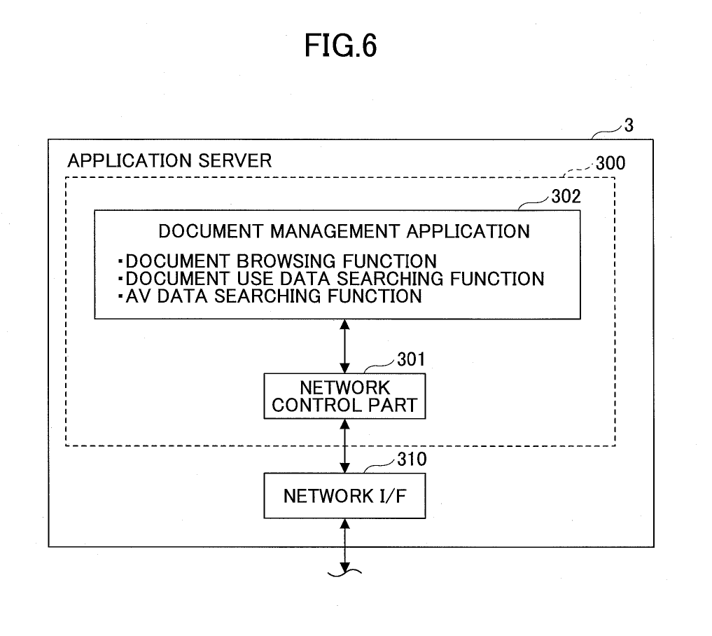

Next, an example of a configuration of the application server 3 is described with reference to FIG. 6. FIG. 6 is a block diagram illustrating the configuration of the application server 3 according to an embodiment of the present invention. As illustrated in FIG. 6, the application server 3 includes a controller 300 and a network I/F 310. Further, the controller 300 includes a network control part 301 and a document management application 302. The functions of the network I/F 310 and the network control part 301 are substantially the same as those of the above-described network I/F 210 and the network control part 201 of FIG. 3.

The document management application 302 includes a document browsing function. The document browsing function is a function that instructs the user terminal 2 or the user terminal 7 (via a network (e.g., networks A, B)) to display data of document material that is stored in the database 4 after the network conference by the user terminal 2 or the user terminal 7 is finished. The document management application 302 also includes a document use data searching function and an AV data searching function. The document use data searching function is a function that searches for the above-described document use data. The AV data searching function is a function that searches for an AV file based on the above-described recording data. By using the document use data searching function and the AV data searching function, the document management application 302 can provide the below-described function of reproducing audio/visual data based on a browse location of a document material to be browsed.

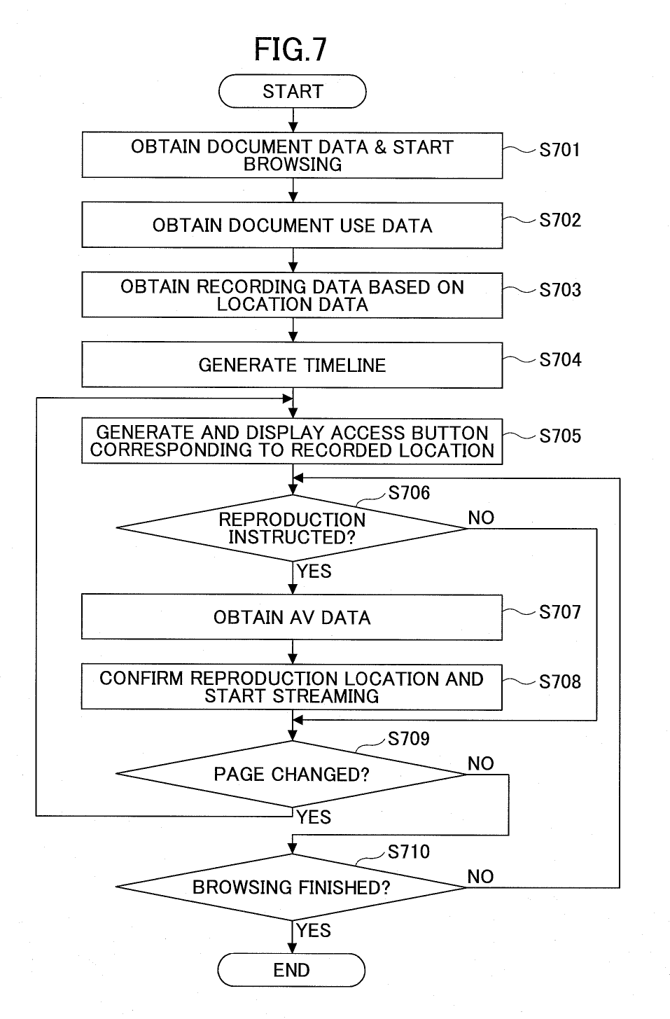

Next, an exemplary operation of the document management application 302 is described with reference to FIG. 7 in a case where a document material is to be browsed with the user terminal 2 (via a browser installed in the user terminal 2) in accordance with an instruction from the document browsing function of the document management application 302. In a case where the document browsing function of the document management application 302 is to be used by the user, a browser of a data processing terminal (e.g., the user terminal 2) is activated. With the browser, the user designates (selects) document material desired to be browsed from the document material data stored in the database 4 and instructs the document management application 302 to obtain the document material data corresponding to the designated document material. Then, the document management application 302 obtains document identification data used for identifying the desired document material.

The document identification data is, for example, data indicating a storage area in which document material is stored in the database 4. In other words, the document identification data is, for example, data indicating a file path such as a URL. Accordingly, after the document management application 302 obtains the designated document material from the database 4 based on the document identification data and transmits the data of the obtained document material to the user terminal 2, the browsing of the document material is started via the browser (Step S701). In this embodiment, the document material is obtained from the database 4 based on the document identification data obtained by the document management application 302. Alternatively, the document management application 302 may obtain data that is unique to the desired document material (unique document material data) for identifying the desired document material. In this alternative case, the user transmits the unique document material data to the application server 3 via a network by operating the user terminal 2.

When the browsing is started, the document management application 302 obtains document use data stored in the database 4 as illustrated in FIG. 4 by using the document use data searching function (Step S702). The document management application 302 uses data for identifying the desired document material (e.g., a document name of the designated document material, a URL of a storage area of the designated document material) as a key to search and to obtain corresponding document use data containing a matching item(s). In this embodiment, the document management application 302 refers to “document file name” and “URL” of FIG. 4 for obtaining the document use data. Thus, in Step S702, the document management application 302 functions as a document browse data obtaining part that obtains document browse data.

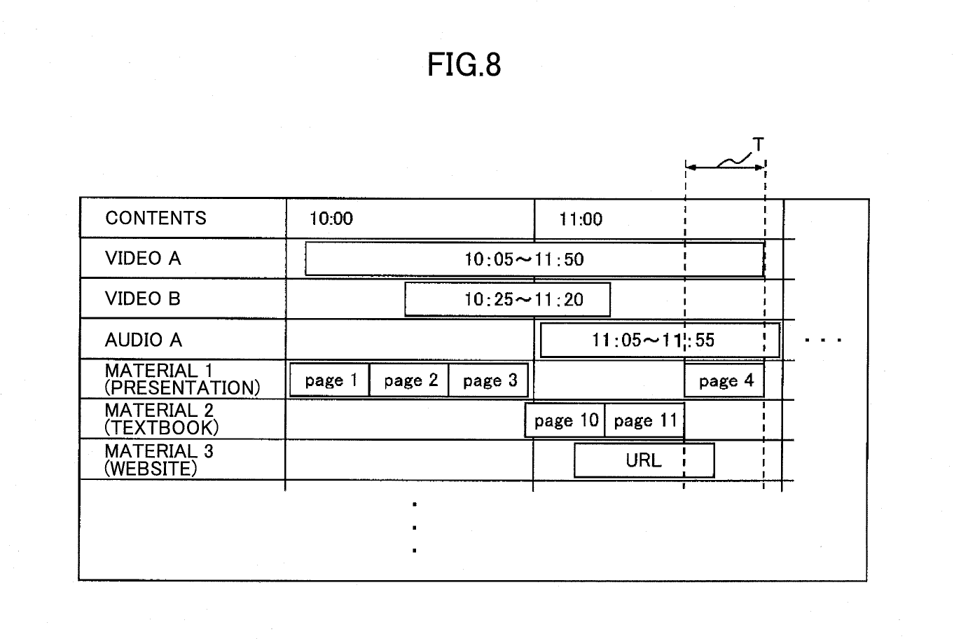

When the document use data is obtained, the document management application 302 searches for and obtains recording data stored in the database 4 as illustrated in FIG. 5 by using the AV data searching function (Step S703). The document management application 302 uses the “location data” included in the document use data as a key to search for and obtain corresponding recording data containing a matching item(s). Thus, in Step S702, the document management application 302 functions as a contents recording data obtaining part that obtains contents recording data. When the recording data is obtained, the document management application 302 generates data of a timeline (see below-described FIG. 8) based on “time/date data” included in the obtained document use data and “time/date data” included in the obtained recording data (Step S704).

FIG. 8 is a schematic diagram illustrating an exemplary timeline indicating the actual length (period) of time in which document materials were displayed and recorded in association with AV data. By using the actual time as an axis, the timeline of FIG. 8 indicates the period in which audio data and video data were recorded based on “recording start time” and “recording period” of FIG. 5 and the period in which document material is displayed based on “page number”, “display start time”, and “display period” of FIG. 4.

Because the network conference system 100 of this embodiment is for enabling an AV file to be searched and viewed/listened to based on document material, the timeline illustrated in FIG. 8 is generated starting from the generation of a timeline of each page of a document material. Then, a timeline of an AV file, which partly or entirely overlaps with the generated timeline of the document material, is generated based on recording data obtained in the above-described Step S703.

Further, the timeline illustrated in FIG. 8 indicates the relationship between timeline data of the document use data and the timeline data of the recording data. Thus, the process of Step S704 of FIG. 7 is not merely a process of generating an image as illustrated in FIG. 8 but is also a process of generating data that enables “display start time” data (corresponding to “page number” data), “display period” data (corresponding to “page number” data), “recording start time” data, and “recording period” data to be determined in correspondence with the same (common) time axis.

By separately recording and storing audio data, visual data, and data of document materials in association with the time in which the audio data, the visual data, and the data of document materials were recorded or displayed, all of the audio data, the visual data, and the data of document materials can be made to correspond to the same time axis as illustrated in FIG. 8. By generating the timeline of FIG. 8, the document management application 302 can identify the portion (location) of the AV (Audio/Visual) file corresponding to the time in which audio or video was recorded in correspondence with the “page number” of the document material designated for browsing. Then, the document management application 302 generates and outputs data of a button of a GUI used for reproducing the identified location of the AV file (Step S705).

In Step S705, the document management application 302, first, functions as a reproduction location identifying part that identifies a reproduction location of an AV file corresponding to the page to be browsed based on a page identification data (i.e. data that identifies the page of document material to be browsed) and data of the timeline illustrated in FIG. 8. After the reproduction location is identified, the user can access the identified location with a browser of the user terminal 2 for reproducing the AV file corresponding to the identified location. Accordingly, the document management application 302 functions as an access data outputting part that generates and outputs data to be accessed by the user.

The data to be accessed by the user may be, for example, data indicating a storage area in the database 4 in which a corresponding AV file is stored (i.e. file path) and a URL indicating the reproduction location of the corresponding AV file. That is, the document management application 302 generates and outputs data of a screen including, for example, a button for requesting access to the URL indicating the reproduction location of the corresponding AV file.

At the time when the browsing of document material is started, the first page is always displayed. Therefore, the document management application 302 generates and outputs data of a GUI for displaying a button to be used in reproducing the recorded location of audio/video data corresponding to the first page. That is, before Step S701, the document management application 302 functions as a page identification data obtaining part that obtains page identification data used for identifying a page to be displayed (i.e. data identifying the first page).

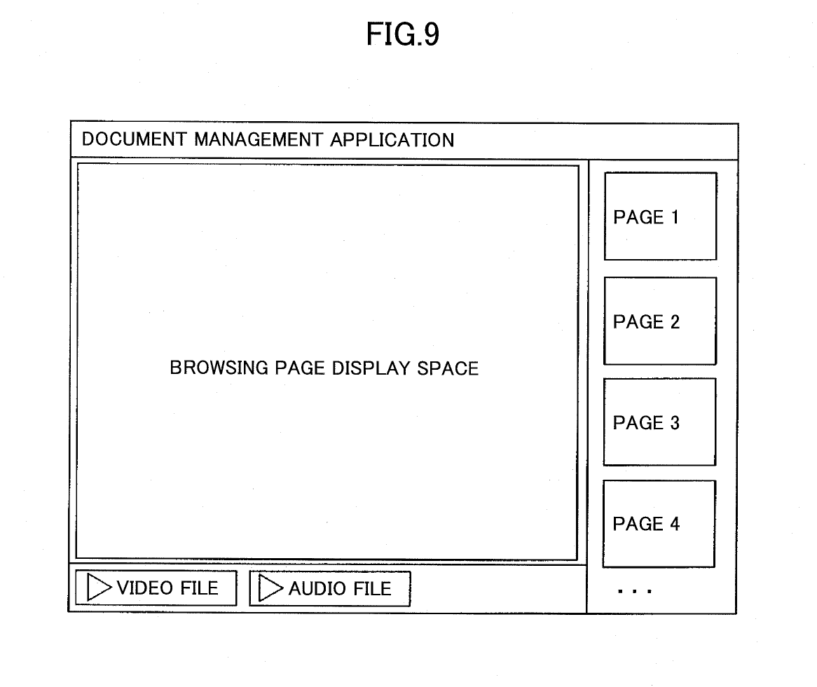

After data of the GUI is output in Step S705, the browser using the document browsing function of the document management application 302 displays a page of document material designated to be browsed along with a button for reproducing a corresponding recorded portion of audio/video data as illustrated in FIG. 9. FIG. 9 is a schematic diagram illustrating an example of a GUI of the document browsing function of the document management application (document browsing GUI).

The document browsing GUI illustrated in FIG. 9 includes a browsing page display space in which a page of document material designated for browsing is displayed. Further, the document browsing GUI also displays each page of the document material being displayed. Further, the document browsing GUI may also include a space into which a designation of a page to be browsed (browsing page) is input in accordance with an operation by the user. As illustrated in FIG. 9, the document browsing GUI displays reproduction buttons corresponding to “video file” and “audio file”. The reproduction buttons are displayed in correspondence with the timeline of FIG. 8, for instructing reproduction of a video file or an audio file that were recorded in a network conference when the browsing page was being displayed at the network conference.

For example, in a case of displaying “page 4” of “material 1” with the document browsing GUI, “page 4” of “material 1” will be displayed in the “browsing page display space” of FIG. 9. As illustrated in FIG. 8, period “T” indicates a period when “page 4” of “material 1” is displayed. Because data of “video A” and data of “audio A” are recorded during period “T”, the reproduction buttons corresponding to “video file” and “audio file” are used as buttons for reproducing “video A” and “audio A” at an appropriate recording time.

When an instruction to reproduce an AV file is input to the document management application 302 via a network by clicking a reproduction button in the screen illustrated in FIG. 9 (Yes in Step S706), the document management application 302 obtains corresponding AV data to be reproduced based on the recording data illustrated in FIG. 5 (Step S707). Then, the document management application 302 confirms the location of the AV data to be reproduced based on the timeline illustrated in FIG. 8 and starts streaming (data streaming) the AV data with respect to the browser used for browsing a corresponding page of document material (Step S708). Accordingly, the browser, which is browsing the document material, can reproduce audio data or visual data corresponding to the page of the document material being browsed.

In addition to the process of streaming, the document management application 302 may add data designating the reproduction location (reproduction location designation data) for starting reproduction to the obtained AV data and transmit the AV data together with the reproduction location designation data to the browser (i.e. user terminal 2) in Step S708. Accordingly, the browser can start reproduction of the AV data from the reproduction location designated by the reproduction location designation data.

Then, in a case where the user operating the browser changes the page of the document material being browsed (Yes in Step S709), the document management application 302 obtains page identification data (i.e. data that identifies the page of document material to be browsed) via the network and repeats the processes performed in Steps S705-S708. In a case where the page of the document material is not changed and browsing of the document material is finished (Yes in Step S710), the document management application 302 terminates the operation illustrated in FIG. 7. Thereby, the operation of the document browsing function of the document management application 302 according to an embodiment of the present invention is finished.

Hence, in a case of generating an AV file containing, for example, audio data and visual data recorded in a network conference or the like by using the document management system according to the above-described embodiment of the present invention, recording data (including, for example, data pertaining to the time and date of the recording and data pertaining to the location of the recording as illustrated in FIG. 5) is generated in association with the AV file. Further, in a case of storing document material displayed in the network conference or the like, document use data including, for example, data pertaining to the time and date of the displaying with respect to each page of the displayed document material and data pertaining to the location of the terminal that displayed the document material as illustrated in FIG. 4 is generated in association with the AV file.

The document management application 302 associates document material data, audio data, and visual data that are stored separately based on “time/date data” and “location data” included in the recording data and the document use data and determines whether the document material data, the audio data, and the visual data were generated in the same network conference or the like. In other words, in a case where the document management application 302 determines that document material data, audio data, visual data indicate the same location data or a location within a predetermined range according to “document use data” and “recording data”, the document management application 302 determines that the audio data and visual data, which were recorded during the period when the document material was displayed, contain explanations or discussion pertaining to the document material. Accordingly, the document management application 302 generates a link to the audio data and the visual data in correspondence with each page of the document material.

Accordingly, in a case where a user browsing document material having plural pages desires to further understand a particular page of the document material and seeks visual data and/or audio data that explains the particular page, the user can immediately start reproduction of the audio data and/or video data corresponding to the particular page. Thereby, the user can easily reproduce contents corresponding to a particular portion (e.g., a page) of the document material.

In the process of obtaining recording data in Step S703 of FIG. 7, the document management application 302 may obtain recording data not only when all of the items in the location data (as illustrated in FIGS. 4 and 5) match but also when a part of the items in the location data match. For example, the document management application 302 determines that recording data matches if the items “latitude”, “longitude”, and “altitude” of the recording data match. Alternatively, the document management application 302 may determine that recording data matches if an item(s) indicates a location within a predetermined range. Alternatively, even where spaces for inputting data corresponding to the items “latitude”, “longitude”, and “altitude” are blank, the document management application 302 may determine that recording data matches if one or more of the items “address”, “building”, “floor”, and “room” match.

As described above, the “location data” of the recording data and the document use data may not only include the location data of one of the terminals of the network conference but also the location data of a terminal of a counterpart(s) of the network conference (e.g., user terminals, 2, 7). Therefore, in this case, the document management application 302 can obtain recording data of both terminals of the network conference in Step S703 of FIG. 7. Accordingly, the user can have a better understanding of the document material by obtaining not only corresponding audio and visual data recorded from one of the terminals of the network conference but also corresponding audio and visual data recorded from another terminal of the network conference.

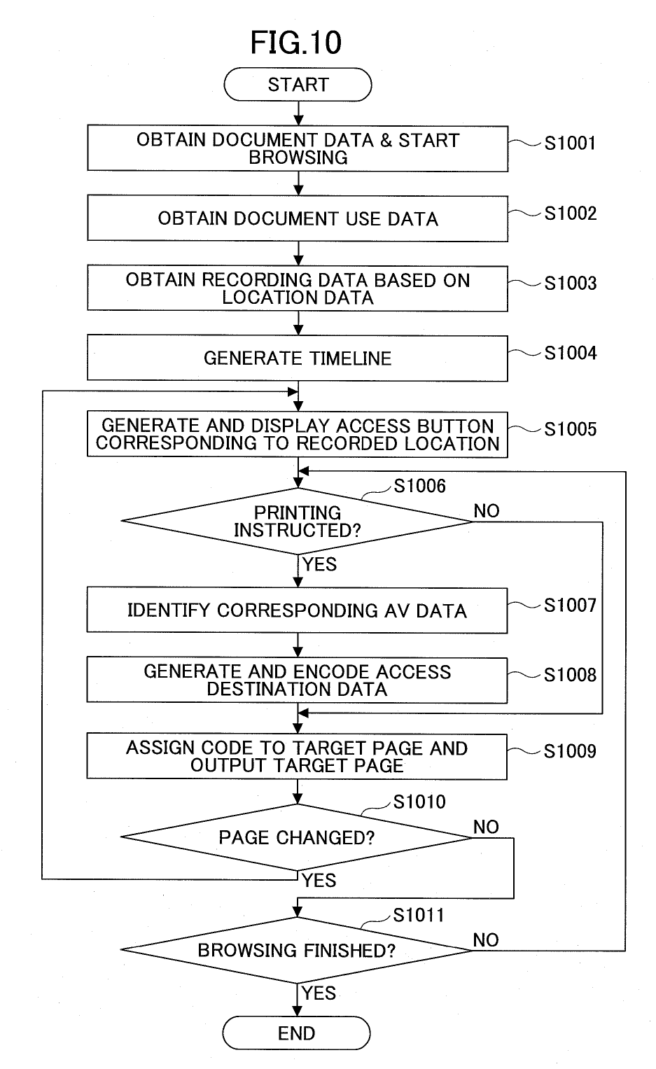

Next, a function of printing (outputting) a page of a document material via the document management application 302 is described in a state where the document material is being browsed. FIG. 10 is a flowchart illustrating an exemplary operation of the document management application 302 in a case where the document management application 302 prints a document material that is being browsed. In a case of printing a document material, the document management application 302 outputs (assigns) encoded data that can be used for accessing audio data and/or visual data corresponding to a page of the document material to be printed. Thereby, the user can easily access corresponding audio data and/or visual data even from the document material that is printed.

The processes performed in Steps S1001-S1005 of FIG. 10 are substantially the same as the processes performed in Steps S701-S705. Accordingly, the screen of FIG. 9 is displayed in the browser of the user terminal 2. When an instruction to print document material is input to the document management application 302 via a network in accordance with an operation performed on the user terminal 2 by the user (Yes in Step S1006), the document management application 302 identifies a storage area in the database 4 in which an AV file corresponding to a target page of the document material (i.e. a page of the document material designated to be printed) is stored and the reproduction location of the AV file to be reproduced based on the recording data of FIG. 5 and the timeline of FIG. 8 (Step S1007).

Then, the document management application 302 generates data of a link that enables the identified reproduction location (e.g., reproduction location identified in a URL format) of the AV file to be reproduced. Then, the document management application 302 converts the data of the link into an encoded data format that can be visually read out (Step 1008). In this example, the data of the link is converted into a QR code (registered trademark). Then, the document management application 302 assigns the QR code (registered trademark) to a blank space of the target page of the document material and outputs image data of the target page including the assigned QR code (registered trademark) to a terminal (e.g., user terminal 2) having a browser operated by the user (Step S1009). Thereby, the user terminal 2 can generate a printing job based on the image data output from the document management application 302 and print the target page of the document material.

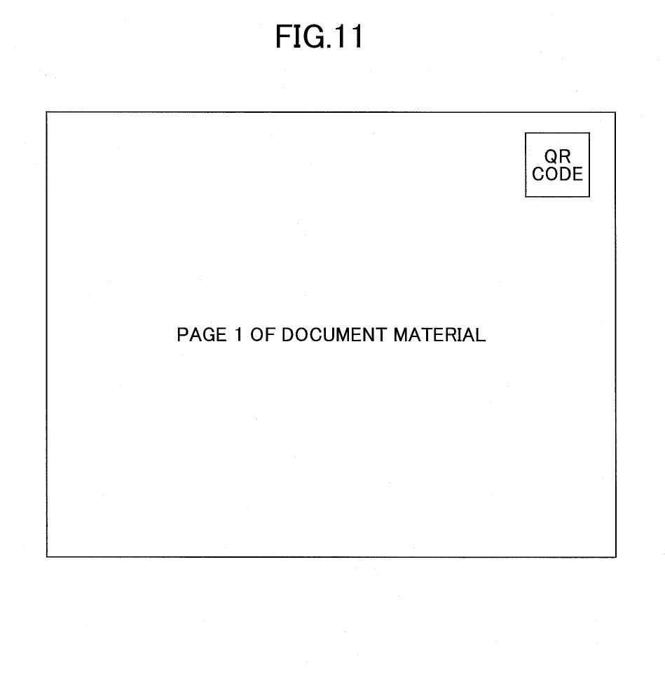

FIG. 11 illustrates an example of the printed target page of the document material. As illustrated in FIG. 11, a QR code (registered trademark) is assigned to a blank space of the target page of document material in accordance with the image data output from the document management application 302. In this embodiment, the QR code (registered trademark) is data obtained by encoding a URL used for accessing the recording location of the AV file corresponding to the timeline of FIG. 8.

Accordingly, by photographing the QRL code (registered trademark) printed on the printed target page with a camera of a mobile terminal (e.g., mobile phone) having a dedicated application or a web camera connected to a data processing terminal (e.g., PC), the user can access the database 4 with the mobile terminal or the data processing terminal and listen to the audio data or view the visual data corresponding to the printed target page.

Hence, with the network conference system 100 according to the above-described embodiment, because document material can be associated with recorded audio/visual data (contents) with respect to actual time and location, the user can easily reproduce the audio/visual data (contents) corresponding to a portion of a printed document material.

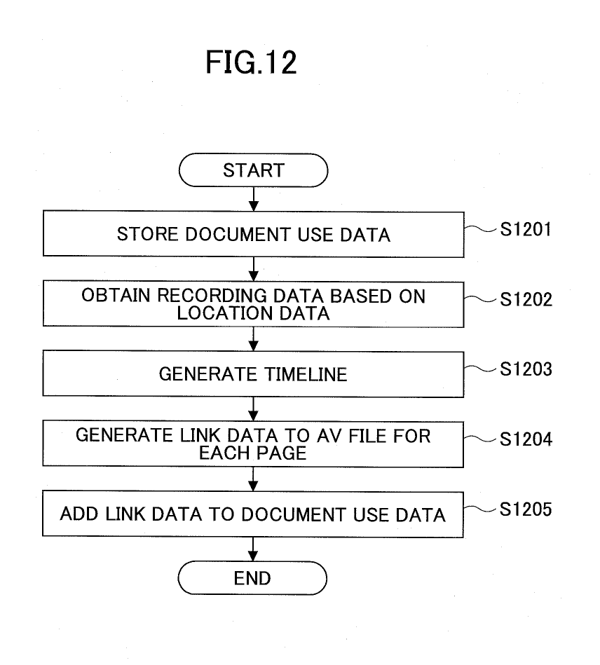

In the operations described above with reference to FIG. 7 (Steps S702-S705) and FIG. 10 (Step S1002-S1005), the process of identifying or obtaining a corresponding AV file is performed after the user begins browsing document material via a browser of, for example, the user terminal 2 or the user terminal 7. Alternatively, as described below with reference to FIG. 12, link data of a reproduction location of an AV file corresponding to each page of the document material can be generated and stored beforehand at the time of storing document material data and the AV file together with document use data and recording data generated by the network conference application.

FIG. 12 is a flowchart illustrating an exemplary operation of the document management application 302 in a case where the document management application 302 generates data of a link (link data) of a reproduction location of an AV file in correspondence with each page of document material when storing data of the document material and the AV file. Similar to Step S703 of FIG. 7, in a case where new document use data is stored in the database 4 (Step S1201), the document management application 302 searches for and obtains recording data stored in the database 4 as illustrated in FIG. 5 (Step S1202). The document management application 302 uses the “location data” included in the new document use data as a key to search for and obtain corresponding recording data containing a matching item(s).

Similar to the Step S704 of FIG. 7, when the recording data is obtained, the document management application 302 generates data of a timeline (timeline data) as described above with FIG. 8 based on data included in the obtained recording data (Step S1203). Based on the generated timeline data, the document management application 302 determines an AV file corresponding to each page of newly recorded document material (corresponding to the new document use data) and a reproduction location of the AV file and generates link data corresponding to the AV file (Step S1204).

In Step S1204, the document management application 302 performs the processes of identifying the reproduction location of the AV file corresponding to a target page, generates access data corresponding to the identified reproduction location, and outputs the generated access data in a manner similar to the processes performed in Step S705 of FIG. 7. However, in Step S1204, a corresponding AV file and a reproduction location are identified with respect to each page of a document of the new document use data. Thus, the document management application 302 generates access data based on the identified AV file and the identified reproduction location.

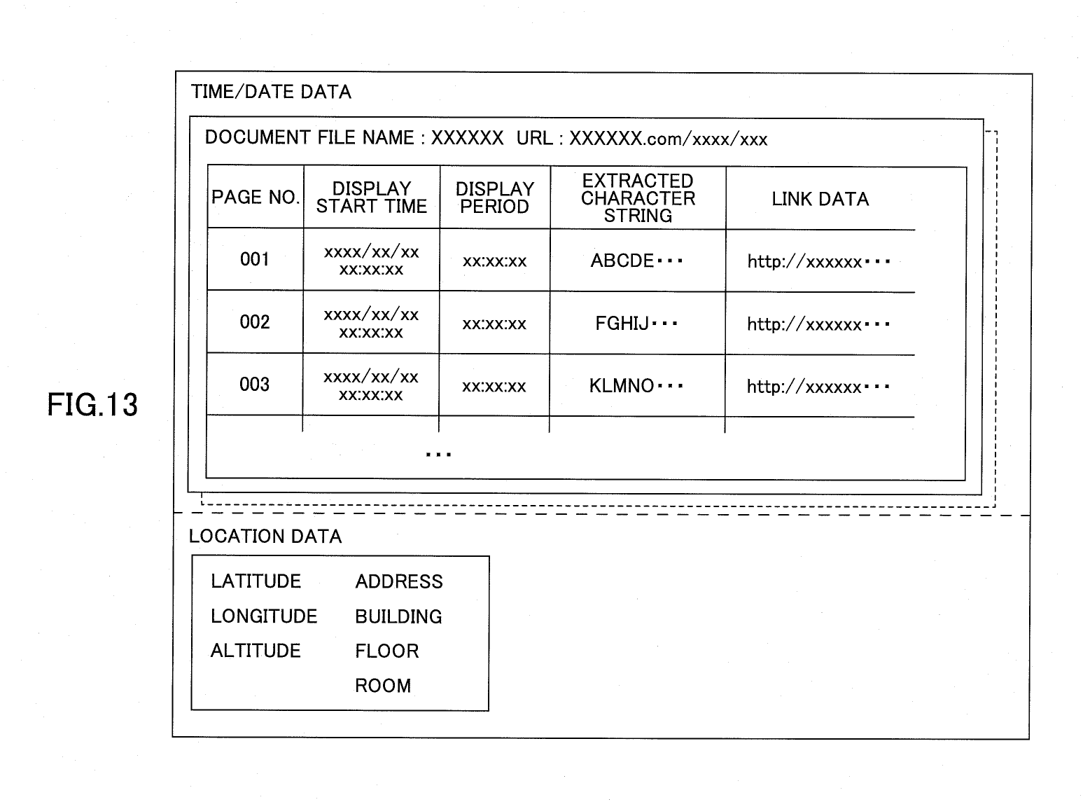

After link data of all of the pages of the document material are generated, the document management application 302 adds the link data in correspondence with “page number” of the document use data illustrated in FIG. 4 (Step S1205). Thereby, the operation of the document management application 302 is finished. With the operation described above with FIG. 12, the document management application 302 can generate document use data as illustrated in FIG. 13 instead of the document use data illustrated in FIG. 4. In the document use data illustrated in FIG. 13, link data indicating corresponding AV files and recording locations are associated with each page of the document material.

Accordingly, in a case where the user of, for example, the user terminal 2 accesses the document management application 302 with the browser of the user terminal 2 and browses a document material stored in the database 4, the document management application 302 can proceed to the process of Step S705 after obtaining the document use data in Step S702. Thereby, the processes performed in Steps S703 and S704 of FIG. 7 can be omitted. Accordingly, responsiveness with respect to the user's operations can be improved during the process of browsing document material, and the workload of the network can be reduced.

In the operation illustrated in FIG. 12, a process of storing new document use data in the database 4 serves as a trigger for causing the document management application 302 to start the operation of FIG. 12. Therefore, in the case where the operation of FIG. 12 is triggered by the storing of new document use data, the document management application 302 may monitor the document use data stored in the database 4 at a predetermined timing(s).

The operation of FIG. 12 can be performed not only in a case where new document use data is stored in the database 4 but also in a case where new recording data is recorded in the database 4. In this case, the document management application 302 uses the “location data” included in the new recording data as a key to search for and obtain corresponding document use data containing a matching item(s).

Although the processes of the above-described embodiments are performed in a case where the network conference application 203 is installed in the user terminal 2 and the user terminal 7, the same advantages can be attained even in a case where an application (e.g., document management application 302) is installed in a server and operated via a browser.

According to the above-described embodiments of the present invention, in a case where document material and a page of the document material are designated, an AV file corresponding to the designated document material and a page of the document material can be identified by using data indicating time/date data (i.e. data indicating the time/date in which the audio data and visual date were stored) and data indicating a location (i.e. data indicating a location in which the document material was browsed) as a key. Thereby, the AV file corresponding to the designated document material and the page of the document material can be viewed and listened to by the user.

Therefore, the configurations of the document use data and the recording data are not limited to those illustrated in FIGS. 4 and 5. As long as the document use data and the recording data include data indicating the time/date and location in which document material has been displayed, the document use data and the recording data may be configured differently with respect to the configurations of the document use data and the recording data illustrated in FIGS. 4 and 5. The same advantages can be attained with respect to the configurations of the document use data and the recording data as long as the document use data and the recording data are associated with corresponding document materials and AV files.

In the above-described embodiments, an AV file recorded in a network conference is searched for with respect to each page of document material displayed in the network conference. The network conference is merely an example. The above-described embodiments may be applied to other systems that associate AV data and document material and use the associated AV data and document material. For example, the above-described embodiments may be applied to a system used for, for example, an audio chat, a video chat, or an online lecture.

The above-described embodiments may also be applied to an ordinary lecture that is not systemized as long as the time in which a page of document material (e.g., a handout for students of the lecture) is displayed in association with the actual time of the lecture and the AV file (e.g., audio/visual data of a lecturer or a student) is recorded in association with the actual time of the lecture. Thus, the same advantages can also be attained for the ordinary lecture by applying the above-described embodiments. In other words, the document management function of the application server 3 can be achieved as long as data such as document use data and recording data are stored in the database 4 regardless of whether data are recorded in the database 4 by the network conference functions of the user terminals 2, 7. In this case, the document use data of FIG. 4 and the recording data of FIG. 5 may be metadata embedded with respect to, for example, document material or an AV file.

Although the document management application 302 installed in the application server 3 is used to perform document management according to the above-described embodiments, document management may also be performed with a device other than the application server 302 (e.g., image forming apparatus 1, projector 5) as long as the device is connected to a network (e.g., networks A, B).

According to the above-described embodiments, the network conference application 203 installed in the user terminal 2 is used to record document use data and recording data in the database 4. Alternatively, the projector 5 may record document use data and recording data in the database 4. In this alternative case, the projector 5 may be provided with a unique function for generating document use data and recording data based on data input to be projected by the projector 5. Alternatively, the network conference application may be installed in the projector 5 for recording document use data and recording data in the database 4.

The present invention is not limited to the specifically disclosed embodiments, and variations and modifications may be made without departing from the scope of the present invention.

The present application is based on Japanese Priority Application No. 2010-243572 filed on Oct. 29, 2010, the entire contents of which are hereby incorporated herein by reference.

What is claimed is:

1. A computer-readable recording medium on which a program is recorded for causing a computer to execute a data management method, the data management method comprising the steps of:
obtaining document identification data used for identifying a target document;
obtaining page identification data used for identifying a page of the target document;
obtaining document use data indicating a display time and a display location in which the page of the target document has been displayed;
obtaining recording data indicating a recording time and a recording location in which AV (Audio Visual) data has been recorded in a case where the recording location is within a predetermined range from the display location;
identifying a portion of the AV data corresponding to the display time of the page of the target document; and
outputting access data that provides access to the portion of the AV data.

2. The computer-readable recording medium as claimed in claim 1, wherein the outputting step includes generating a screen to which an instruction for reproducing the portion of the AV data is input.

3. The computer-readable recording medium as claimed in claim 1, wherein the data management method further comprises a step of:
outputting encoded data to the page of the target document in a case of printing the page of the target document.

4. The computer-readable recording medium as claimed in claim 1, wherein the identifying of the identifying step is based on a timeline enabling the display time of the page of the target document and the recording time to be determined in correspondence with a same time axis.

5. The computer-readable recording medium as claimed in claim 1, wherein the data management method further comprises the steps of:
obtaining another recording data indicating another recording time and another recording location in which another AV data has been recorded in a case where another document use data is obtained, the another recording location being within a predetermined range from the another display location;
identifying another portion of the another AV data corresponding to the another display time of the page of the target document;
generating another access data that provides access to the another portion of the another AV data; and
adding the another access data to the another recording data in association with the page of the target document.

6. The computer-readable recording medium as claimed in claim 1, wherein the data management method further comprises the steps of:
obtaining another document use data indicating another display time and another display location in which the page of the target document has been displayed in a case where another recording data is obtained, the another recording data indicating another recording time and another recording location in which another AV data was recorded in a case where the another recording location is within a predetermined range from the display location;
identifying another portion of the another AV data corresponding to the another display time of the page of the target document;
generating another access data that provides access to the another portion of the another AV data; and
adding the another access data to the another recording data in association with the page of the target document.

7. The computer-readable recording medium as claimed in claim 5, wherein the data management method further comprises a step of:
outputting the another access data that is added to the another recording data in association with the page of the target document.

8. The computer-readable recording medium as claimed in claim 6, wherein the data management method further comprises a step of:
outputting the another access data that is added to the another recording data in association with the page of the target document.

9. A data management apparatus for comprising:
a first obtaining unit configured to obtain document identification data used for identifying a target document;
a second obtaining unit configured to obtain page identification data used for identifying a page of the target document;
a third obtaining unit configured to obtain document use data indicating a display time and a display location in which the page of the target document has been displayed;
a fourth obtaining unit configured to obtain recording data indicating a recording time and a recording location in which AV (Audio Visual) data has been recorded in a case where the recording location is within a predetermined range from the display location;
an identifying unit configured to identify a portion of the AV data corresponding to the display time of the page of the target document; and
an outputting unit configured to output access data that provides access to the portion of the AV data.

10. A data management method comprising the steps of:
obtaining document identification data used for identifying a target document;
storing the document identification data in a storage unit;
obtaining page identification data used for identifying a page of the target document;
storing the page identification data in the storage unit;
obtaining document use data indicating a display time and a display location in which the page of the target document has been displayed;
storing the document use data in the storage unit;
obtaining recording data indicating a recording time and a recording location in which AV (Audio Visual) data has been recorded in a case where the recording location is within a predetermined range from the display location;
storing the recording data in the storage unit;
identifying a portion of the AV data corresponding to the display time of the page of the target document; and
outputting access data that provides access to the portion of the AV data.
